(19) United States
(12) Patent Application Publication
(10) Pub. No.: US 2005/0011686 A1
(43) Pub. Date: Jan. 20, 2005

(54) Track and guide system for a skid-steer vehicle

(76) Inventor: Douglas William Mcllwraith, Reedy Creek (AU)

Correspondence Address: Michael A. Cantor;Cantor Colbourn LLP, 55 Griffin Road South, Bloomfield, CT, 06002, US

(21) Appl. No.: 10/622,873

(22) Filed: Jul. 17, 2003

(51) Int. Cl. B62D 55/04

(52) U.S. Cl. 180/9.26

(57) ABSTRACT

A skid-steer mini-loader (10) has a pair of wheels (12) on each side thereof, and a pair of tracks (15) each mounted on the wheels (12) on a respective side of the mini-loader. Each track (15) is the tread section of a tire which has had its side walls removed. The mini-loader also has a guide disk (16) mounted on at least one side of each of the wheels (12), each disk (16) being located adjacent an associated edge of the track (15) on the respective side of the mini-loader.

This invention relates to a track and guide system for a skid-steer vehicle. In particular, the invention is directed to a tire tread track and associated track guides for a skid-steer mini-loader.

### BACKGROUND ART

In recent years, small skid-steer loaders (known as “mini-loaders”) have become popular for light earthworking operations, particularly in confined areas. Examples of such mini-loaders are illustrated in U.S. design Pat. Nos. 359,497 and 431,574. The operator stands on a small platform at the rear of the mini-loader.

These mini-loaders are mounted on wheels which are driven hydraulically. The wheels of a mini-loader are normally non-steerable, and the mini-loader is steered by varying the hydraulic drive to the wheels on one side of the mini-loader relative to the drive to the wheels on the opposite side. The hydraulic “skid-steer” drive enables the mini-loader to turn sharply, and eliminates the need for complex steering and gearing mechanisms. The popularity of these mini-loaders is due, at least in part, to their manoeuvrability.

Due to their relatively light weight and small wheels, the known mini-loaders sometimes lose traction, particularly in loose or wet ground. Load carrying capacity is also restricted by traction limitations.

Skid-steer operation of the wheels may also cause damage to ground cover, such as lawns.

Although it is known to use tracks on earthmoving vehicles to provide greater traction, known track systems are not considered suitable for mini-loaders. The application of tracks to mini-loaders normally requires specially designed rollers and track links suitable for such small vehicles. The custom design and manufacture of such track systems adds substantially to the cost of the mini-loaders, rendering them financially prohibitive, or at least making the tracked mini-loaders unattractive from a commercial point of view. Further, stones and small rocks tend to become wedged between the tracks and drive sprockets in use, requiring a high degree of track maintenance.

It is an aim of this invention to provide a track system for a skid-steer vehicle which overcomes or ameliorates one or more of the disadvantages described above, or which at least provides the consumer with a useful choice.

### SUMMARY OF THE INVENTION

In one form, the invention provides a track suitable for a skid-steer vehicle having at least a pair of wheels on each side thereof, the track comprising a tread section of a tire.

Typically, the track is a tread section from a conventional pneumatic tire normally used on a larger vehicle. The tire may be new or used. The tire size is selected so that the tread section is suitably dimensioned for use as a track on the skid steer vehicle.

The tread section can be obtained by cutting the side walls out of the tire. The tread section can then be mounted on the wheels on one side of the skid-steer vehicle, and used as a low cost track.

Alternatively, the track can be formed as a new tread section using an existing tire mold, with the side wall portions of the mold being blocked off during the molding process.

In another form, the invention provides a guide system for a skid-steer vehicle having at least a pair of wheels on each side thereof and adapted to have a track mounted on the wheels on each side, the guide system comprising a disk mounted on at least one side of each one of the pair of wheels, the disk being located adjacent an associated edge of the track.

The track is typically a tire tread, and the disk(s) serve to retain the track on the wheels, particularly when the track is subjected to lateral forces tending to dislodge the track from the wheels, e.g. when the skid-steer vehicle is turned sharply.

Preferably, the disk is provided at least at the inner side of each wheel.

In the preferred embodiment, inner and outer disks are provided on each wheel, on either side of the track. The inner and outer disks are fixed to a hub on which the wheel is mounted. The hub, in turn, is removably mounted to a drive hub on the chassis of the skid-steer vehicle.

Each wheel may suitably comprise a pneumatic tire mounted on a hub. However, the term “wheel” as used in this specification is intended to cover any suitable equivalent, such as a roller, where the context permits.

Typically, the skid-steer vehicle is a stand-on mini-loader.

In order that the invention may be more fully understood and put into practice, a preferred embodiment thereof will now be described with reference to the accompanying drawings.

### BRIEF DESCRIPTION OF THE DRAWINGS

FIG. 1 is a right side perspective of a mini-loader chassis having a track system according to one embodiment of this invention.

FIG. 2 is a left side perspective of the mini-loader of FIG. 1.

FIG. 3 is a side elevation of the track system of FIG. 1.

FIG. 4 is a sectional elevation along A-A of FIG. 3.

FIG. 5 is an exploded perspective view of a wheel and track guides of the track system of FIG. 3.

### DESCRIPTION OF PREFERRED EMBODIMENT

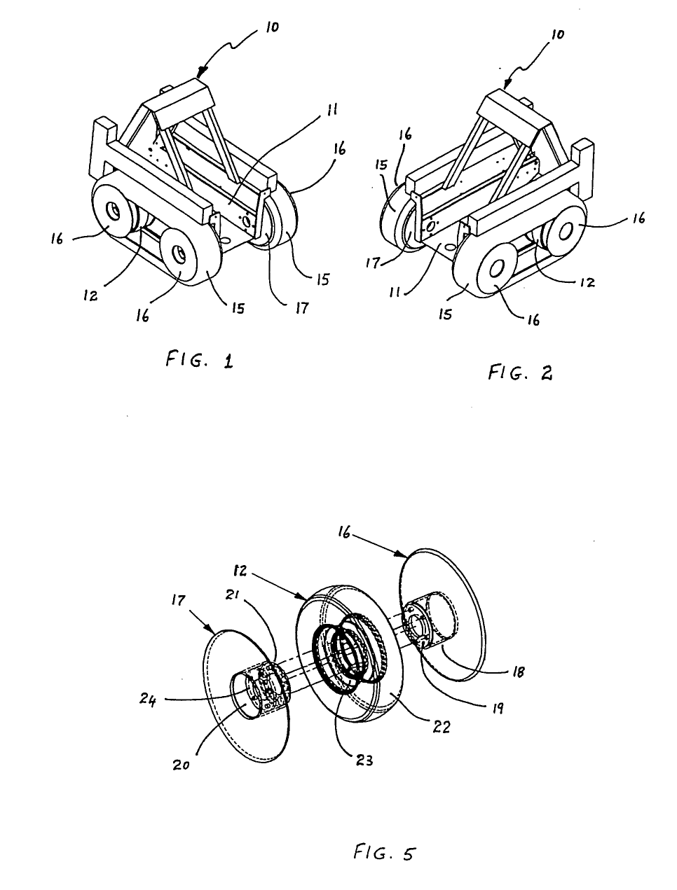

As shown in FIGS. 1 and 2, a skid-steer mini-loader 10 comprises a chassis 11 mounted on two pairs of wheels 12 which are driven hydraulically by a power plant (omitted for clarity). The operator stands on a platform (not shown) at the rear of the machine. Typically, the wheels on each side are driven in unison and, for this purpose, one wheel on each side may be driven hydraulically and the other wheel is connected to the driven wheel by a chain and sprocket assembly. The mini-loader is steered by differential drive to the wheels on opposite sides of the chassis, in a known “skid-steer” manner.

In the illustrated embodiment, a track 15 is mounted on the wheels 12 on each side of the chassis 11. Since a tracked arrangement is used, the normal chain and sprocket assembly between the wheels can be omitted, as the driven wheel drives the other wheel by the track 15.

The wheels 12 each comprise a pneumatic tire on a steel rim. The tires can be deflated to permit a track to be fitted onto both tires at a side of the mini-loader, and then inflated to tension the track and retain it on the wheels as shown in FIGS. 1 and 2.

The track comprises a tread section of a rubber tire. The tire can be a conventional new or used pneumatic tire, selected so that it is dimensionally suitable for mounting to the wheels 12 on the mini-loader. The side walls of the tire are cut off, and the remaining tread is mounted to the wheels 12 as an endless track 15. (Part of the side walls may optionally be retained on the tread so that the track has short side walls.)

The use of a tread section from a conventional tire as the track enables the mini-loader to be fitted with tracks in a very economical manner. No specialised manufacturing facility is required, as the track can be obtained from pre-existing standard tires. Moreover, unlike conventional tracks which comprise pin-jointed rigid links, the tire tread tracks 15 are continuous flexible elements which achieve a greater contact with the wheels on which they are mounted, and avoid the wear normally associated with track links.

Furthermore, since the tracks 15 are made from rubber tire treads, they are able to stretch to some degree. Thus, if stones are caught, between the track and a wheel, the track can distend slightly to accommodate the caught material. Conventional linked tracks normally cannot stretch to any significant extent, and if material is caught between the wheels and the track, the added tension on the track can damage pin joints or wheel mountings and bearings.

Other advantages of the tire tread track include:
(i) the tracks 15 provide increased traction for the mini-loader;
(ii) the tracks 15 provide increased ground clearance for the mini-loader chassis;
(iii) since the tracks provide greater ground contact area than the wheels alone, there is less ground pressure, and consequently less damage to ground cover;
(iv) the tracks enable the mini-loader to be used on loose soil and sand, rough ground and snow;
(v) the tracks 15 enable the mini-loader to achieve greater accessibility;
(vi) the tracks 15 provide the mini-loader with the ability to travel up and down stairs; and
(vii) smaller wheels can be used inside the tire tread track.

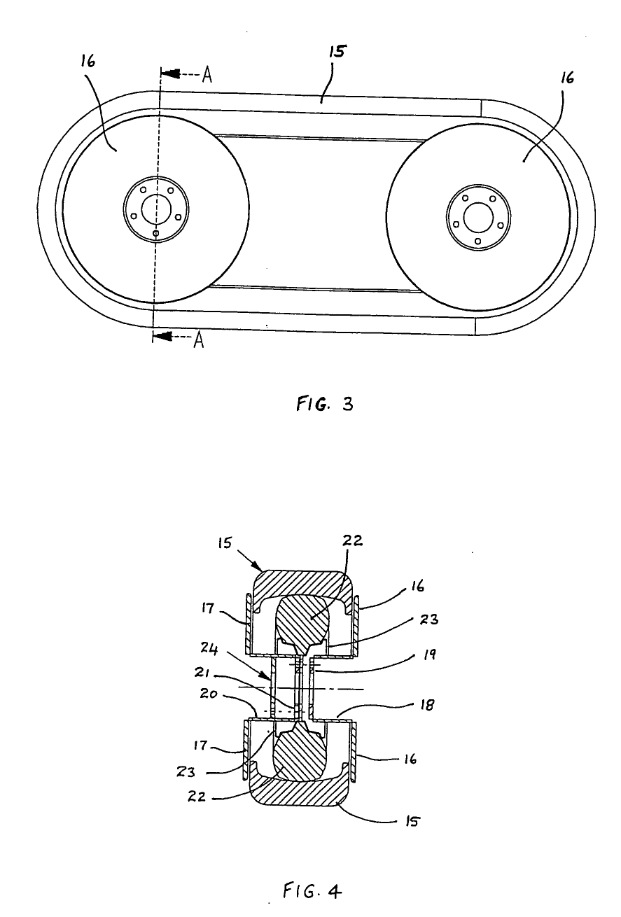

The track system of the illustrated embodiment also includes track guides, shown in more detail in FIGS. 3-5. Each wheel is provided with an outer track guide 16 and an inner track guide 17, each in the form of an upright radial plate or disc. The track guides are typically formed of steel plate. The outer track guide 16 is fixed, e.g. by welding, to a central hub portion 18 having a radial mounting plate 19. The inner track guide 17 is fixed to a hub portion 20 having a radial mounting plate 21. The inner track guide 17 also has a drive attachment plate 24 fixed to its hub 20.

Each wheel 12 suitably comprises a pneumatic tire 22 mounted on a metal rim 23. The hub portions 18, 20 locate within the rim 23.

In use, the drive attachment plate 24 of each wheel is bolted to a respective wheel hub (not shown) on the chassis 11. The associated wheel rim 23 and wheel 22 are mounted on the hub 20. Tracks 15 are placed around the pair of wheels at each side of the mini-loader. (The spacing of the wheels 12 on each side of the chassis may be adjustable to facilitate the mounting of the track 15 and its subsequent tensioning. Alternatively, the wheels can be deflated to facilitate the mounting of the track, and inflated to tension the track).

The track system can be used with only the inner track guides 17. Preferably however, the outer track guides 16 are also used. Each outer track guide 16 is fitted to a respective wheel by bolting its mounting plate 19 to the mounting plate 21 of the associated inner track guide 17.

The track guides 16, 17 are positioned alongside the longitudinal edges of the track 15. In normal operation, the track will be retained on the wheels 12 by its tension. However, during sharp turns, particularly on slopes, lateral forces on the track 15 may tend to dislodge it from the wheels. In such situations, the track guide 16, 17 serve to retain the track 15 on its wheels by providing lateral support.

The track guides 16, 17 need not extend radially to the outer surface of the track. It is sufficient if they overlap radially with a portion of the track. The longitudinal edges of the track 15 are located radially within the outer surface of the track 15. Thus, the track guides do not normally contact the ground.

The foregoing describes only one embodiment of the invention, and modifications which are obvious to those skilled in the art may be made thereto without departing from the scope of the invention. For example, instead of forming the track 15 by cutting the side walls from a conventional tire, the track 15 can be made from a standard tire mold after blocking the side wall sections of the mold.

1. In a skid-steer vehicle having at least a pair of wheels on each side thereof, a track mounted on each pair of wheels and comprising a tread section of a tire.

2. A track as claimed in claim 1, wherein the tread section is obtained by cutting side walls out of a conventional pneumatic tire.

3. A track as claimed in claim 1, wherein the tread section is obtained from a conventional tire mold having side wall portions of the mold blocked off.

4. A track as claimed in claim 1, wherein each of the wheels comprises a hub having a pneumatic tire thereon.

5. In a skid-steer vehicle having at least a pair of wheels on each side thereof and a track mounted on the pair of wheels on each side, a guide system comprising a plurality of disks, each of the disks being mounted upright on at least one side of a respective one of the wheels adjacent an associated edge of the track in use.

6. A guide system as claimed in claim 5, wherein a said disk is provided at least at an inner side of each said wheel.

7. A guide system as claimed in claim 5, and wherein a pair of said disks are provided at opposite sides of each said wheel.

8. A guide system as claimed in claim 5, wherein each said disk is connected to a hub of the respective wheel.

9. A skid-steer vehicle having a pair of wheels on each side thereof, a pair of tracks each mounted on the wheels on a respective side of the vehicle, each said track being the tread section of a rubber tire which has had its side walls removed, and an upright guide disk mounted on at least one side of each of the wheels, each said disk being located adjacent an associated edge of the track on the respective side of the vehicle.

10. A vehicle as claimed in claim 9, wherein the vehicle is a ride-on mini-loader, and each said wheel comprises a metal hub having a pneumatic tire thereon.
